(19) United States
(12) Patent Application Publication
(10) Pub. No.: US 2008/0282205 A1
(43) Pub. Date: Nov. 13, 2008

(54) UNIFIED LAUNCHER USER INTERFACE SYSTEM AND METHOD FOR INTEGRATING MULTIPLE DISPARATE ENVIRONMENTS ON AN ELECTRONIC DEVICE

(75) Inventors: Elizabeth Dykstra-Erickson, San Francisco, CA (US); Hiroyuki Toki, San Jose, CA (US); Tom Chavez, Santa Clara, CA (US)

Correspondence Address: BERRY & ASSOCIATES P.C., 9255 SUNSET BOULEVARD, SUITE 810, LOS ANGELES, CA, 90069, US

(73) Assignee: ACCESS SYSTEMS AMERICAS, INC., Sunnyvale, CA (US)

(21) Appl. No.: 12/027,262

(22) Filed: Feb. 6, 2008

Related U.S. Application Data
(60) Provisional application No. 60/888,541, filed on Feb. 6, 2007.

(51) Int. Cl. G06F 3/14

(52) U.S. Cl. 715/866

(57) ABSTRACT

A unified launcher user interface system and method for integrating a plurality of applications in different runtime environments on an electronic device, for example a mobile device is disclosed. The unified launcher user interface system includes a user interface presenting icons representing the plurality of applications configured to run in separate runtime environments, wherein the applications are launched from the unified launcher user interface system within a normalized environment.

### PRIORITY CLAIM

This application claims the benefit under 35 U.S.C. § 119(e) of U.S. Provisional Patent Application No. 60/888,541 filed on Feb. 6, 2007, entitled “Unified Launcher for Integrating Multiple Disparate Environments on a Mobile Device,” which is herein incorporated by reference.

### FIELD OF THE INVENTION

The present invention generally relates to user interface systems for electronic devices, for example mobile devices, personal digital assistant devices or the like. More particularly, the present invention relates to a unified launcher user interface system and method for normalizing the applications on an electronic device such as a mobile device by presenting a common set of general appearances, behaviors, etc., for the applications, regardless of the particular environments in which those applications are executed.

### BACKGROUND OF THE INVENTION

A myriad of different applications are continuously developed for electronic devices (e.g. mobile devices) to execute different improved functions and these applications typically operate in multiple different runtime environments. For example, in mobile devices with telephone capability, Windows Mobile™ devices can run Java applications. However, different runtime environments for hard buttons on the mobile device for different applications have their own unique behavior including distinct differences in installing, launching, and deleting, as well as different inherent behaviors such as navigation and mappings. Each application additionally uses a different widget set and all participate to a different degree in system-wide notifications.

A typical mobile device user has to learn each environment to become familiar, recognize and memorize the differences, and deal with each environment's constraints in order to operate applications successfully. Each environment uses different widget sets, according to different policies and user interaction guidelines, and each appear differently to the user. Text input fields on mobile devices can consist of single-line entry or multiple-line entry.

All these differences are time consuming to learn and serve only to confuse a user. Therefore, there is a need for a unified application launcher system and method, which can make the launching of applications in different runtime environments seamless for the user of electronic devices such as mobile devices.

These and other advantages are provided by various embodiments of the present invention that are described here.

### SUMMARY OF THE INVENTION

The present invention provides a system and method with a unified launcher capability for integrating a plurality of applications in different runtime environments on an electronic device such as a mobile device. In an exemplary embodiment of the present invention, the system and method comprises a user interface including icons representing a plurality of different applications such that the applications are configured to run or operate in separate runtime environments, and wherein the applications are launched from a unified launcher capability within a normalized environment.

Additional features and advantages of the invention will be set forth in the description which follows, and in part will be obvious from the description, or may be learned by practice of the invention.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram illustrating the various hardware and software components of an exemplary electronic device such as a mobile device, which utilizes the system and method of the present invention;

FIG. 2 is a schematic diagram of an exemplary embodiment of the user interface of the system and method of the present invention; and

FIG. 3 is a diagram of a prior art implementation.

### DETAILED DESCRIPTION OF ILLUSTRATIVE EMBODIMENTS

In the detailed description that follows, which is for purposes of explanation and illustration only and not limitation, specific details and/or references are set forth, such as particular networks, communication systems, computers, terminals, devices, components, techniques, data and network protocols, software products and systems, operating systems, development interfaces, hardware, etc., in order to provide a thorough understanding of the present invention.

However, it will be apparent to one skilled in the art that the present invention may be practiced in other embodiments that depart from these specific details. It should be understood that any well-known networks, communication systems, computers, terminals, devices, components, techniques, data and network protocols, software products and systems, operating systems, development interfaces, and hardware components may be used and description of the details of these are omitted so as not to obscure the description of the present invention.

Electronic devices such as mobile devices can offer many different runtime environments. The present invention here is illustrated in the context of a mobile device, but it should be understood that the user interface systems and methods discussed here can be applied to any device with similar functionalities. For example, a typical mobile device can offer Access Linux Platform (“ALP”), Garnet OS, and Java, each with its own particular behaviors. To make the experience seamless for the mobile device user and to minimize the problems that are pertinent to each runtime environment, the system and method of the present invention with a unified launcher enables users to determine which applications reside on their mobile device.

In accordance with the system and method of the present invention, the launching experience is “normalized” for a user so that the differences in runtime environment for each application are transparent to the user. The system lists all applications in a unified launcher, e.g., ALP native applications, Java applications (but not individual participants in a midlet suite), and Garnet OS (“operating system”) applications. Each application has the same launch experience and the environment displayed is the respective runtime environment.

In accordance with another aspect of the present invention, further aspects of integration such as managing memory allocation for each runtime environment are optimized. In accordance with yet another aspect of the invention, the installation routine for each runtime environment is normalized so that the user experiences similar mechanisms regardless of the runtime environment. In still another aspect of the present invention, the setting of user preferences for each runtime environment is normalized so that the user experiences similar mechanisms regardless of the runtime environment.

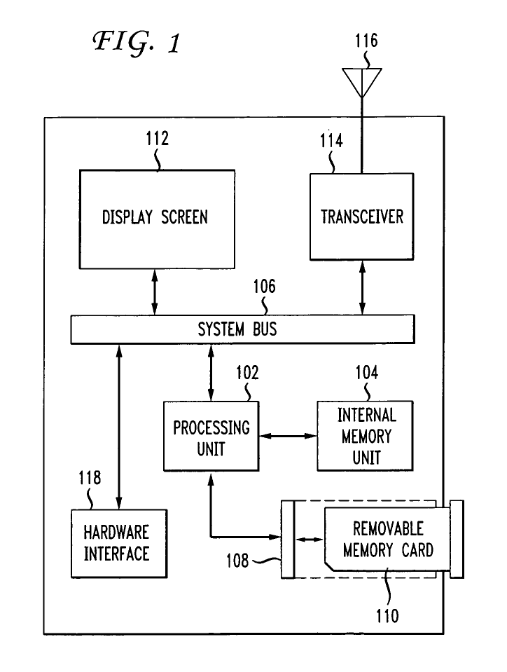

FIG. 1 shows the various hardware and software components of an exemplary electronic device such as a mobile device 100 illustrated here for executing methods of the present invention. The electronic device may take the form of a portable computer, a personal digital assistant (PDA), an enhanced cell phone, or any other computer system having a relatively small display screen and wireless communication capability. The mobile device includes a processing unit, 102, adapted to run an operating system platform and application programs. The processing unit 102 is also adapted to control other complements of the mobile device as explained here. An internal memory unit 104 comprises a read-only memory (ROM) to store critical files and a random access memory (RAM) to store other files as needed. The mobile device of FIG. 1 may also include a removable memory card interface 108 as to accommodate a memory card 110.

A display screen 112 is coupled to the processing unit 102 through a bus 106 and thereby receives input from the processing unit 102 that provides displays on the screen 112. The system of FIG. 1 also includes a transceiver unit 114, coupled to an antenna 116, and to the processing unit 102. The transceiver 114 provides for transmission and reception of wireless signals over a designated range of frequencies, allowing the mobile device connections to external devices and networks, such as a wireless telephone network or the internet. Data received from external sources via the transceiver 114, such as media content obtained from an online depot may be delivered via the bus 106 to the processing unit 102 and thereafter stored in available memory. As depicted in FIG. 1, a hardware interface 118 is coupled to a keypad or switches on the body of the mobile device.

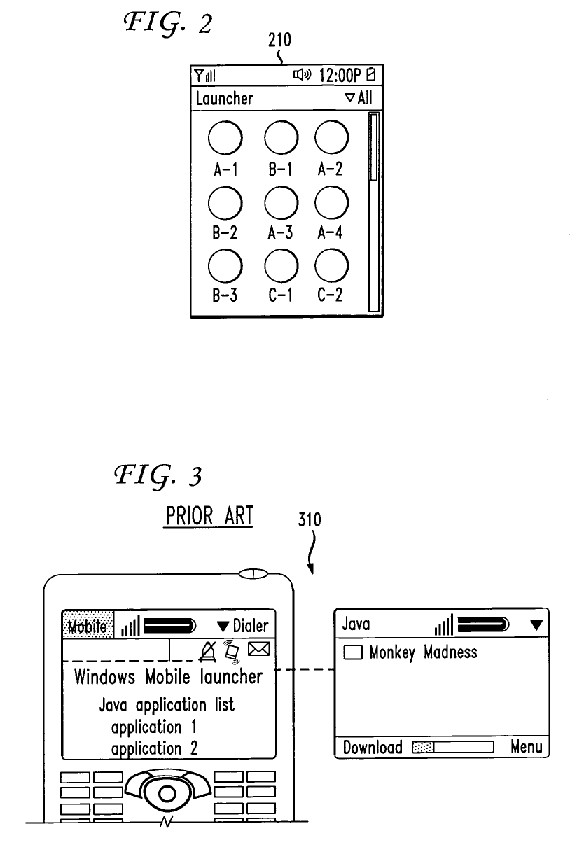

Referring to FIG. 2, there is shown one embodiment of the system with a unified launcher in accordance with the present invention. As generally indicated by reference numeral 210, the unified launcher system shown integrates applications with disparate runtime environments. For example, reference letter “A” indicates a Linux application, reference letter “B” indicates a Garnet OS application, and reference letter “C” indicates a Java application. The unified launcher system view allows the user to see all applications in one single viewing.

By way of comparison, referring now to FIG. 3, which illustrates a prior system, a Windows Mobile™ launcher is generally indicated by reference numeral 310. A Java application is shown in the applications list, but a user must launch the Java application and navigate inside that runtime environment to ascertain whether there are any Java applications on the electronic device. In this example, the Java icon appears within the applications list. The application title illustrated is “Monkey Madness,” which does not appear displayed until the Java icon is launched.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A user interface system for integrating a plurality of applications operating in different runtime environments on an electronic device, comprising:
a processing unit configured to execute an operating system platform and application programs stored in a memory;
a display device coupled to the processing unit to receive and provide displays on the display device;
a user interface launching capability providing displays for the plurality of applications operating in separate runtime environments, wherein the applications are configured to launch by the user interface launching capability within a normalized environment.

2. A user interface system according to claim 1, wherein the displays for the plurality of applications include icon representations.

3. A method for integrating a plurality of applications operating in different runtime environments on an electronic device, comprising the step of:
utilizing a processor to execute an operating system platform and application programs stored in a memory;
providing displays on a display device coupled to the processor for the plurality of applications operating in separate runtime environments, wherein the applications are configured to provide a single display for viewing by a user;
providing a user interface launching capability configured to launch the applications within a normalized environment.

4. A method according to claim 3, wherein the displays for the plurality of applications include icon representations.
